(19) United States
(12) Patent Application Publication
(10) Pub. No.: US 2017/0041436 A1
(43) Pub. Date: Feb. 9, 2017

(54) System and Method for the Sharing of Structured Tagged Content where all Content Originates from a Structured Content Management System

(71) Applicant: Anthony I Lopez, JR., Dana Point, CA (US)

(72) Inventor: Anthony I Lopez, JR., Dana Point, CA (US)

(21) Appl. No.: 14/817,884

(22) Filed: Aug. 4, 2015

(51) Int. Cl. H04L 29/06; H04L 29/08

(52) U.S. Cl. CPC H04L 67/42; H04L 65/60; H04L 67/1097; H04L 67/06

(57) ABSTRACT

The present invention includes a system and method for the sharing of structured tagged content where all content originates from a structured content management system. Content is classified by way of the URL, Supporting URL, Content Detail URL, and Originating URL and Categorically classified. As content is modified in any way (i.e. edited, deleted) in the content management system, the same content displayed and published on the website (URL) is also automatically modified throughout all devices where the website (URL) is rendered. Communication of content can be performed instantaneously on any and all devices, including but not limited to desktop/laptop, mobile and tablet devices, by selecting the individual's or individuals' website/s (URL/s) to whom they want to share. Shared content may be viewed on the receivers' websites (URLs) and their content management systems. Content shared through the system is automatically rendered throughout all devices using the system. Social bilateral communication of content through the content management system is instantaneous. The system would allow users future retrieval of content stored in the secured content management system whether or not the content's supporting URL or originating URL still exists or has been deleted or modified.

### DEFINITIONS

Prior to describing the present invention, it is useful to provide definitions for some key terms used herein.

Content: broadly interpreted to include, without exclusion, digital media that is, or could be accessed on the Internet such as image files, audio files, text files, video files, and any combinations and equivalents thereof.

Desired Content: broadly interpreted to include, without exclusion, any specific wanted data on a digital content platform, such as images, audio, text, video, and any combinations and equivalents thereof.

Atomic Content: broadly interpreted as a single element such as an image, text, or video that is not naturally divisible into smaller units.

Composite Content: broadly interpreted as a content type which has many atomic resources within it, for example, a html web page consisting of many script and image files.

Associated Content: broadly interpreted to include, without exclusion, any and all data of interest, desired or not, associated with an element—whether said element is atomic or composite. Most often, an element of content will have associated content within its composite parent content item.

URL (Uniform Resource Locator): broadly interpreted as a character string that constitutes a reference to atomic and/or composite resources on the World Wide Web.

Supporting URL or Source Location: a URL describing the location of an element or atomic content, which makes up composite content.

Originating URL or Source Location: a URL where original content comes from (typically composite).

Content Detail URL: some atomic content that is embedded in a particular instance of composite content will have associated code indicating a URL which provides additional information about said content. This URL is referred to as the content detail URL.

Web Browser (or browser): broadly interpreted as retrieving, presenting, and traversing information resources on the World Wide Web.

Contextual Information: broadly interpreted as data related to content, including but not limited to URL, supporting URL, originating URL, description, links, metrics, index, or identification.

Unstructured Content: broadly interpreted as information that either does not have a pre-defined data model or is not organized in a pre-defined, classified or categorized method.

Content Management System: broadly interpreted as a computer application that allows publishing, editing, modifying, organizing and deleting of content as well as maintenance from a central interface.

Web Master: broadly interpreted as the person who maintains a particular website.

Storage System: broadly interpreted as a place where data is held in a digital form for access by a computer processor.

Device: broadly interpreted as a mechanical or electronic equipment or thing made for a particular purpose including but not limited to desktops/laptops, mobile devices, and tablet devices.

Website: broadly interpreted as a location connected to the Internet that maintains one or more pages on the World Wide Web.

Tagging: broadly interpreted as attaching a label to.

Digital Media: broadly interpreted as digital images, digital video, digital audio, digital audio visual media, computer games, digital books, digital text, and/or the like.

Viewers: broadly interpreted as persons who look at or inspect something.

Followers: broadly interpreted as adherents or devotees of a particular person, cause or activity.

Public: broadly interpreted as of or concerning the people as a whole.

### BACKGROUND OF THE INVENTION

Sharing of content has become more popular as technology and dependency on that technology has advanced. Some platforms allow users to quickly share content to others who are notified of said shared content they may find interesting. Sharing of content is often done by way of sharing a link from a platform using an external email system or tagging individual profiles to content on a social networking platform. Users will then view the content by clicking the link back to the platform from where it was shared or by receiving a notification informing the user of shared content that can be viewed on the social networking platform. Sharing tagged content has become more demanding and popular in today's society for both personal and business purposes.

Typically users are constantly on social networking platforms posting content such as photos or statuses that they want to share to their viewers, followers or the public. On some conventional social platforms, the user or content sharer can upload content and tag an individual or individuals who are members of that social platform. These tagged members typically receive notifications that provide them with a hyperlink to view the tagged content on the content sharer's profile page on the shared social platform. The tagged members may decide to also display the shared content on their profile page. In some cases, non-members of the social platform may also be tagged and receive notifications via external email systems which provide a hyperlink to the shared content but the non-members would not be able to interact with users on the social platform.

Although tagging allows users to quickly notify others of content they want to share or they may find interesting, the content shared is unstructured. Typically said content ascends in time relative to the overall aggregate of content which continues to multiply and grow until only the nearest in time shared content is all that becomes relevant. The transitory aspect of this sharing is fun and quick but historically unorganized. A method for quickly searching and locating specific tagged content from what could be thousands of tagged content is not typically available. To find specific tagged content today that might be much later in time requires the user to search the abyss of unstructured tagged content until the user locates that desired content they were initially searching for. The invested time and delay to do so is hardly practical in today's fast sharing social environments. The problem is that the content tagged and shared is typically unstructured as it does not have a pre-defined data model or is not organized in any pre-defined manner. It is cumbersome for users to attempt to separately store content then navigate through archival storage to retrieve a desired content, then post or share that content on a social platform. Further, after users post or share content from their storage devices to their social platforms they are essentially storing the same content in two or more locations resulting in duplicated content and unnecessary storage consumption. In addition, the tagged members of the shared content who are receiving the same unstructured content typically would save said content on their social platforms. If available the tagged members must then save the content on another storage medium, or multiple storage mediums, such as their hard drive or cloud storage system to further use said content again. The content saved is again unstructured which causes the same time delays when needing to use or share the content quickly to others.

As stated, over time the amount of content a member has tagged increases significantly. Since the content is unstructured, retrieval of specific content can be overwhelming as searching for a particular desired content typically requires users to scroll through a massive aggregate of content a member may have acquired over time, which have not been deleted from their social platform. Typically a user cannot search through content within social platforms because it is unstructured and uncategorized. Further, users are unable to search their content on the social platforms by way of who, what, when, and where. Due to the lack of a viable content management system, which would organize content for search and retrieval the user is left with the tenuous, time-consuming task of looking for that analogy of a needle in an overgrowing, unorganized content haystack.

Therefore, a solution that would be more practical and desirable would be a system and method that allows users to share tagged content that is also categorized and organized content from a secure content management system through any and all devices, including but not limited to a traditional computing device, mobile device or tablet device. A secure content management system assists users in converting all of their unstructured content into organized, departmentalized, structured content for specific search, retrieval and communication of content through instantaneous sharing within the system. Users would then be able to view shared content on their respective websites (URLs) and bilaterally communicate their structured content immediately and instantaneously utilizing their devices with others, which interface with their respective content management systems simultaneously rendering all content on all devices.

### BRIEF SUMMARY OF THE INVENTION

The present invention includes a system and method for the sharing of structured tagged content where all content originates from a structured content management system. Content is classified by way of the URL, Supporting URL, Content Detail URL, and Originating URL and Categorically classified. As content is modified in any way (i.e. edited, deleted) in the content management system, the same content displayed and published on the website (URL) is also automatically modified throughout all devices where the website (URL) is rendered. Communication of content can be performed instantaneously on any and all devices, including but not limited to desktop/laptop, mobile and tablet devices, by selecting the individual's or individuals' website/s (URL/s) to whom they want to share. Shared content may be viewed on the receivers' websites (URLs) and their content management systems. Content shared through the system is automatically rendered throughout all devices using the system. Social bilateral communication of content through the content management system is instantaneous. The system would allow users future retrieval of content stored in the secured content management system whether or not the content's supporting URL or originating URL still exists or has been deleted or modified.

The following description is presented to enable one of ordinary skill in the art to make and use the invention and is provided in the context of a patent application and its requirements. Various modifications to the embodiment will be readily apparent to those skilled in the art and the generic principles herein may be applied to other embodiments. Thus, the present invention is not intended to be limited to the embodiment shown but is to be accorded the widest scope consistent with the principles and features described herein.

### BRIEF DESCRIPTION OF THE DRAWINGS

FIG. 1 is a block diagram illustrating an exemplary embodiment of the system and method for the sharing of structured tagged content where all content originates from a structured content management system according to the present invention;

FIG. 2 is a flowchart illustrating an exemplary embodiment of a method of how the system determines, identifies, and stores specific elements according to the present invention;

FIG. 3 is a flowchart illustrating an exemplary embodiment of a method of how the system determines, stores and categorizes specific elements according to the present invention;

FIG. 4 is a flowchart illustrating an exemplary embodiment of a method of how the system is initialized from a client through the server process to retrieve content according to the present invention;

FIG. 5 is a flowchart illustrating an exemplary embodiment of a method of how the system is initialized from a client through the server process to share content with categorized content according to the present invention;

FIG. 6 is a flowchart illustrating an exemplary embodiment of a method of how the system is initialized from a client through the server process to display content according to the present invention;

FIG. 7 is a flowchart illustrating an exemplary embodiment of a method of how the system is initialized from a client through the server process to search for shared content according to the present invention;

### DETAILED DESCRIPTION

It should be appreciated that the present invention can be implemented in numerous ways, including as a process, or apparatus, a system, or a computer readable medium such as a computer readable storage medium or a computer network wherein program instructions are sent over optical or electronic communication links. It should be noted that the order of disclosed processes may be altered within the scope of the invention.

A detailed description of one or more preferred embodiments of the invention is provided below along with accompanying figures that illustrate by way of example the principles of the invention. While the invention is described in connection with the embodiments, it should be understood that the invention is not limited to any embodiment. On the contrary, the scope of the invention is limited only by the appended claims and the invention encompasses numerous alternatives, modifications, and equivalents. For the purpose of example, numerous specific details are set forth in the following description in order to provide a thorough understanding of the present invention. The present invention may be practiced according to the claims without some or all of these specific details. For the purpose of clarity, technical material that is known in the technical fields related to the invention has not been described in detail so that the present invention is not unnecessarily obscured.

An element according to the present invention encompasses digital content to include but not limited to meta data, text, image files, sound files, and video files. In order for the invention to properly provide and display interactive contextual information and originating URL for content, content is sent through a smart server wherein they are processed to either a database server or media store server where the content is separated into component content parts and associated URL, supporting URL, content detail URL, and originating URL. On the database server textual elements are indexed while on the media store server if applicable, a unique identifier is generated in association with an element that can be anything from an image file or video file. Requests from users are then sent back through the smart server to the user's device where the user can view all content containing the request. If pre-existing content is sent through the system, the system will filter out the duplicate content, replacing it with a unique identifier. In this manner, media is stored and retrieved without duplication, while still allowing varied meta data to be associated with said content.

In an exemplary embodiment, the invention is implemented in software, which includes but is not limited to firmware, resident software, microcode, etc. The invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus or device. The medium can be an electronic, magnetic, optical, electromagnetic, infrared, or semiconductor system (or apparatus of device) or a propagation medium.

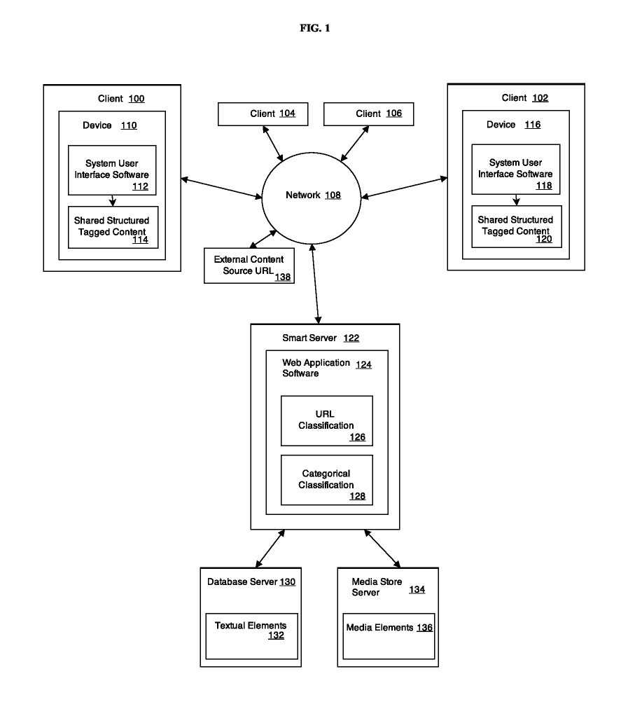

FIG. 1 is a block diagram illustrating an exemplary embodiment of a system displaying multiple hardware and software components of a system for the sharing of structured tagged content where all content originates from a structured content management system. A client's 100 device 110 interacting with a System User Interface Software 112 which displays shared structured tagged content 114, interacts and sends client 100 commands through the network 108 to a Smart Server 122 where Web Application Software 124 executes said commands to determine, classify, store, search, and share content by way of URL Classification 126 and Categorical Classification 128 from an external content source URL 138 to a client's 102 device 116 interacting with a System User Interface Software 118 which displays shared structured tagged content 120. The content is processed either to a Database Server 130 where textual element indexing 132 occurs or to a Media Store Server 134 where media elements are assigned unique identifiers 136 in association with relevant applicable content.

Other clients, as represented in 104 and 106 running on other system user interface software may also be connected to the network 108. If the content from the URL is changed, moved, deleted or its access restricted, these clients will be unable to utilize said URLs for content retrieval. Whereas client 100 and 102 of this invention will be able to retrieve from the Smart Server 122 the archived content independently of its external existence on its originating server. Clients 104 and 106 connected to the network 108 may view clients' 100 and 102 shared structured tagged content 114 and 120 from their own devices.

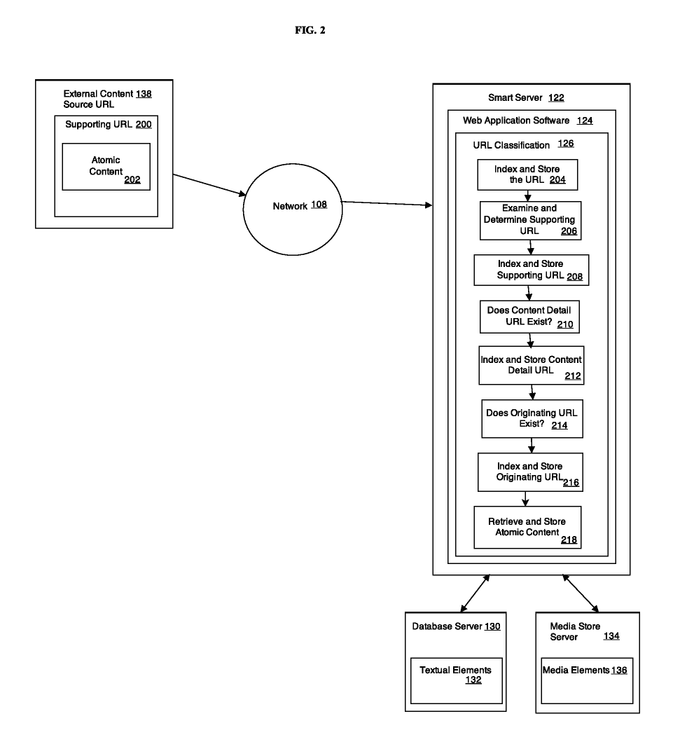

FIG. 2 is a flowchart that further illustrates an exemplary embodiment of a system and method of URL Classification 126 displaying through multiple hardware and software components whereby the atomic content 202 with a supporting URL 200 from an external content source URL 138 is retrieved through the network 108 by the Smart Server 122 where the Web Application Software 124 indexes and stores the URL 204, examines and determines supporting URL 206, indexes and stores supporting URL 208, determines content detail URL 210, indexes and stores content detail URL 212, determines originating URL 214, indexes and stores originating URL 216, and retrieves and stores atomic content 218.

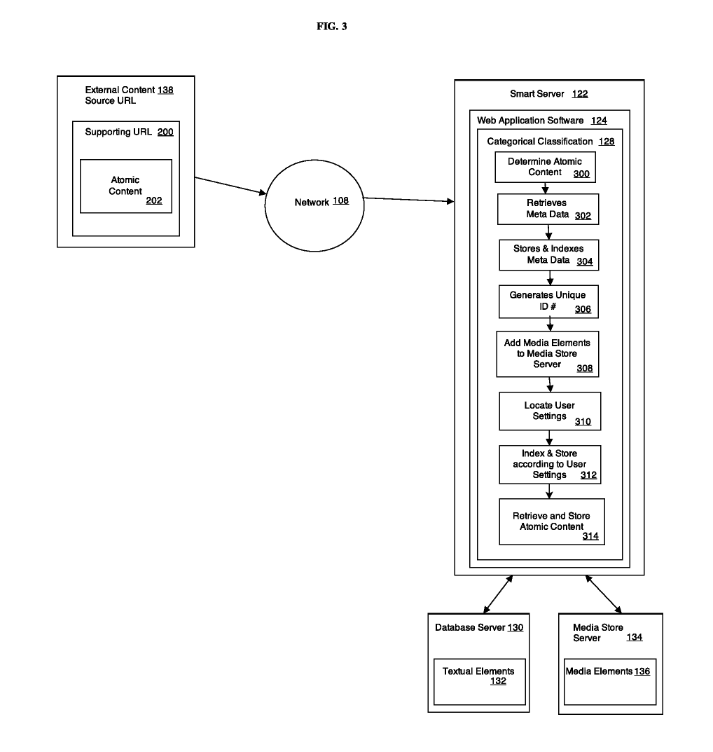

FIG. 3 is a flowchart that further illustrates an exemplary embodiment of a system and method of Categorical Classification 128 displaying through multiple hardware and software components whereby the atomic content 202 with a supporting URL 200 on an external content source URL 138 is retrieved through the network 108 by the Smart Server 122 where the Web Application Software 124 determines atomic content 300, retrieves meta data 302, stores and indexes meta data 304, generates unique id # 306, adds media elements to media store server 308, locates user settings 310, indexes and stores according to user settings 312, retrieves and stores atomic content 314.

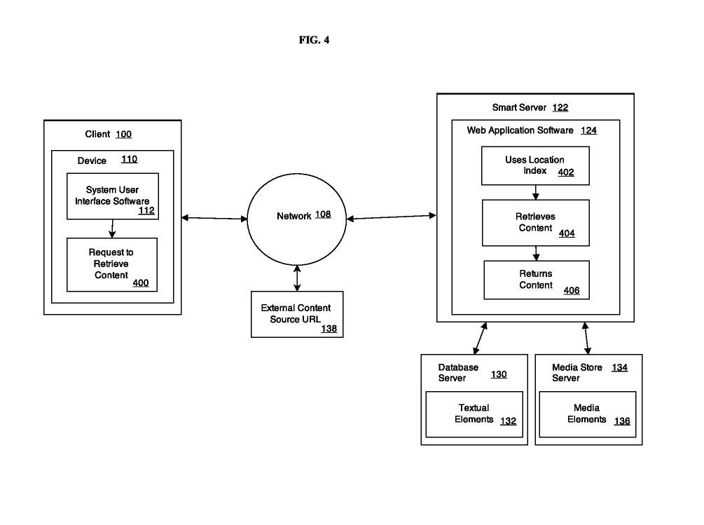

FIG. 4 is a flowchart that further illustrates an exemplary embodiment of a system and method displaying through multiple hardware and software components whereby requests to retrieve content 400 sent from the client 100 interacting with the System User Interface Software 112 through the network 108 are received by the Smart Server 122 where the Web Application Software 124 uses location index 402, retrieves content 404, and returns content 406 to the client 100 through the network 108 interacting with the System User Interface Software 112 where it is viewed on the device 110.

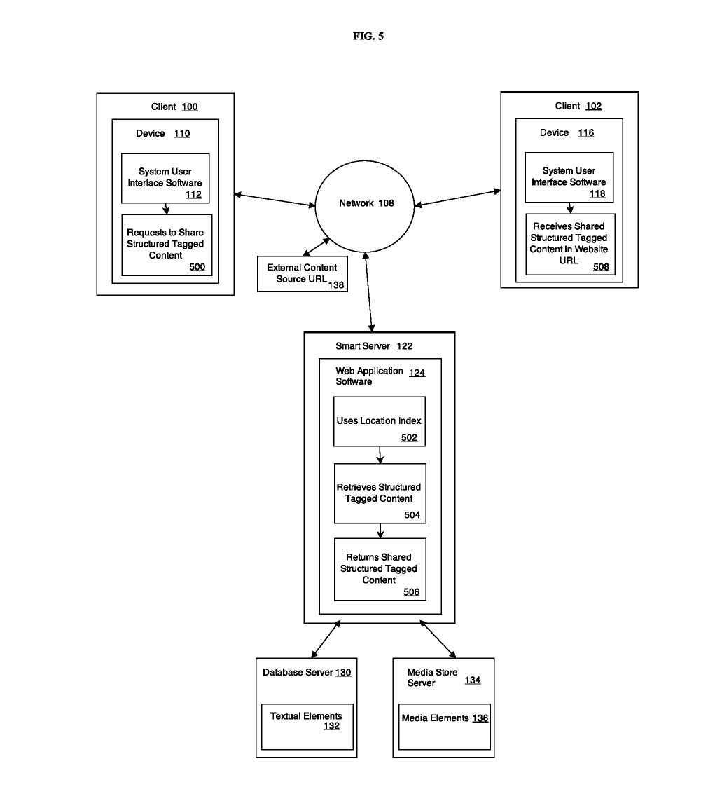

FIG. 5 is a flowchart that further illustrates an exemplary embodiment of a system and method displaying through multiple hardware and software components whereby client 100 requests to share structured tagged content 500 interacting with the System User Interface Software 112 sent through the network 108 are received by the Smart Server 122 where the Web Application Software 124 uses location index 502, retrieves structured tagged content 504, and returns structured tagged content 506 where client 102 receives shared structured tagged content in website URL 508 on a device 116 interacting with system user interface software 118.

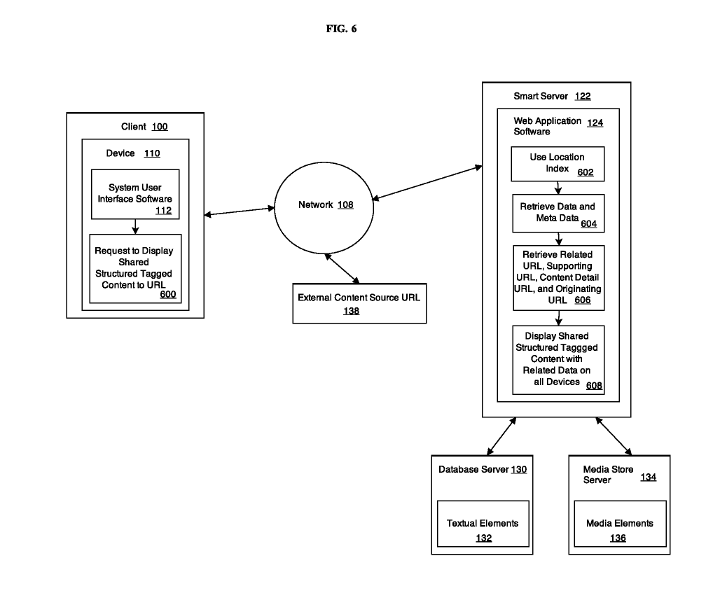

FIG. 6 is a flowchart that further illustrates an exemplary embodiment of a system and method displaying through multiple hardware and software components whereby client 100 requests to display shared structured tagged content to URL 600 interacting with the System User Interface Software 112 sent through the network 108 are received by the Smart Server 122 where the Web Application Software 124 uses location index 602, retrieves data and meta data 604, retrieves related URL, supporting URL, content detail URL and originating URL 606, and displays shared structured tagged content with related data on all devices 608.

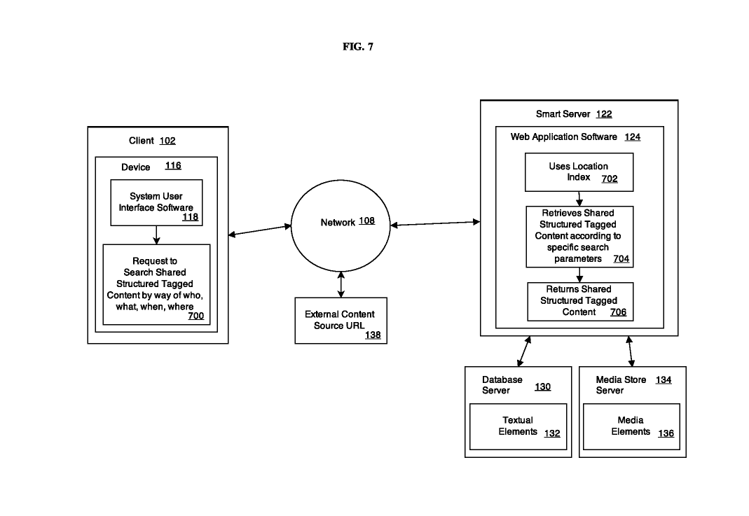

FIG. 7 is a flowchart that further illustrates an exemplary embodiment of a system and method displaying through multiple hardware and software components whereby client 102 requests to search shared structured tagged content by way of who, what, when, where 700 interacting with the System User Interface Software 118 sent through the network 108 are received by the Smart Server 122 where the Web Application Software 124 uses location index 702, retrieves shared structured tagged content according to specific search parameters 704, and returns shared structured tagged content 706.

REFERENCES

| | | |
|---|---|---|
| 8271596 | September 2012 | Haskins et al. |
| 8291032 | October 2012 | Lamb et al. |
| 20040205133 | October 2004 | Adler |
| 7555486 | June 2009 | Venguerov |
| 20100274750 | October 2010 | Oltean et al. |
| 8392538 | March 2013 | Lee |
| 7945653 | May 2011 | Zuckerberg, et al. |

What is claimed is:

1. A method, for the sharing of structured tagged content where all content originates from a structured content management system, the method comprising: of an operation to be performed on a smart server; perform the following steps on a smart server which further interacts with the appropriate Database Server and Media Store Server to: classify, store, retrieve, manage, and rate content; wherein the client device does not block thereby allowing one or more operations to be performed at the client device; receiving from the smart server the content, its URL, its supporting URL, and/or originating URL.

2. A method as recited in claim 1, the method comprising: of an operation to be performed on a smart server by way of URL Classification; in response to the client request, perform the following steps on a smart server which further interacts with the Database Server and Media Store Server to: index and store the URL, examine and determine supporting URL, index and store supporting URL, determine content detail URL, index and store content detail URL, determine originating URL, index and store originating URL, retrieve and store atomic content.

3. A method as recited in claim 1, the method comprising: of an operation to be performed on a smart server by way of Categorical Classification; in response to the client request, perform the following steps on a smart server which further interacts with the Database Server and Media Store Server to: determine atomic content, retrieve meta data, store and index meta data, generate unique id #, add media elements to media store server, locate user settings, index and store according to user settings, retrieve and store atomic content.

4. A method as recited in claim 1, the method comprising; of an operation to be performed on a smart server; in response to the client request at a client device, perform the following steps on a smart server which further interacts with the Database Server and Media Store Server to: use location index, retrieve content, and return content.

5. A method as recited in claim 1, the method comprising; of an operation to be performed on a smart server; in response to the client request at a client device, perform the following steps on a smart server which further interacts with the Database Server and Media Store Server to: use location index, retrieve structured tagged content, and returns shared structured tagged content.

6. A method as recited in claim 1, the method comprising; of an operation to be performed on a smart server; in response to the client request at a client device, perform the following steps on a smart server which further interacts with appropriate database servers and media servers to: use location index, retrieve data and meta data, retrieve related URL, supporting URL, content detail URL, and/or originating URL, and display shared structured tagged content with related data on all devices.

7. A method as recited in claim 1, the method comprising; of an operation to be performed on a smart server; in response to the client request at a client device, perform the following steps on a smart server which further interacts with appropriate database servers and media servers to: use location index, retrieve shared structured tagged content according to specific search parameters, and return shared structured tagged content.

8. A method as recited in claim 1, wherein the client device displays the response via a browser.

9. A method as recited in claim 1, wherein the client device operates on the server data that allows for client side modification of server data received.

10. A method as recited in claim 9, wherein the client device being configured to receive user input that performs a change that requires an operation to be performed on the smart server; respond to the client input by: generating a request for the operation to be performed on the smart server; one or more operations to be performed in response to the request; and sending the response to the client device.

11. A method for a computer readable medium on a client device, the method comprising: receiving user input at a client device that performs a change that requires an operation to be performed on the smart server; in response to the user input, perform the following steps on the client device: generating request for the operation to be performed on the smart server; and sending the request to the smart server; wherein the client device does not block while waiting for the response from the smart server to the request, thereby allowing one or more operations to be performed at the client device after the client device sends the request and before the client device receives the response to the request; receiving the response, processing elements that were generated upon the user input.

12. A method as recited in claim 11, wherein the client device displays the response via a browser.

13. A method as recited in claim 11, wherein the client device operates on the server data that allows for client side modification of server data received.

14. A method as recited in claim 13, wherein the client device being configured to receive user input that performs a change that requires an operation to be performed on the smart server; respond to the client input by: generating a request for the operation to be performed on the smart server; one or more operations to be performed in response to the request; and sending the response to the client device.
